(19) United States
(12) Patent Application Publication
(10) Pub. No.: US 2023/0339819 A1
(43) Pub. Date: Oct. 26, 2023

(54) SINGLE PHASE ORGANIC-INORGANIC SOL-GEL

(71) Applicants: BWXT NOG Technologies, Inc., Lynchburg, VA (US); Clemson University Research Foundation, Clemson, SC (US)

(72) Inventors: Keith B. RIDER, Prospect, VA (US); Kevin HOUR, Charlotte, NC (US); Fei PENG, Clemson, SC (US)

(21) Appl. No.: 18/110,552

(22) Filed: Feb. 16, 2023

Related U.S. Application Data
(60) Provisional application No. 63/333,589, filed on Apr. 22, 2022.

(51) Int. Cl. C04B 35/624; B01J 13/00; B01J 13/02; C04B 35/524; C04B 35/56; C04B 35/58; C04B 41/00

(52) U.S. Cl. CPC C04B 35/624; B01J 13/0026; B01J 13/0065; B01J 13/02; C04B 35/524; C04B 35/56; C04B 35/58; B01J 13/0069; C04B 41/0072; C04B 2235/48; C04B 2235/3852; C04B 2235/3817

(57) ABSTRACT

A single phase, organic-inorganic sol-gel with controlled rheology that can be solidified readily and converted into a ceramic material is provided. The organic-inorganic sol-gel may be uranium-based or cerium-based. Highly spherical ceramic microspheres such as uranium or cerium gel microspheres are fabricated and are able to be converted to homogeneous ceramics after thermal decomposition at high temperatures. Pure phase UC₂ can be obtained upon carbothermal reaction. Pure phase U₂N₃ can also be obtained after converting UC₂ to U₂N₃.

### CROSS-REFERENCE TO RELATED APPLICATIONS

This application claims priority from U.S. Provisional Patent Application No. 63/333,589, filed on Apr. 22, 2022, in the United States Patent and Trademark Office. The disclosures of which are incorporated herein by reference in their entireties.

### STATEMENT REGARDING FEDERALLY SPONSORED RESEARCH OR DEVELOPMENT

This invention was made with government support under Contract 80MSFC17C0006 awarded by NASA. The government has certain rights in the invention.

### FIELD OF THE INVENTION

The present invention relates to a sol-gel, more particularly to a single phase, organic-inorganic sol-gel with controlled rheology.

### BACKGROUND OF THE INVENTION

A sol-gel is a solution of metal ions that has been modified to produce a viscous gel that can be processed into a glassy or ceramic material. A sol-gel is frequently used as a precursor of a ceramic material. Ceramics are produced from a sol-gel in order to provide control over the shape of the final ceramic object as well as over the physical properties of the ceramic.

A conventional sol-gel process introduces carbon in the form of discrete carbon particles so that the metal and carbon are in two separate phases. A conventional sol-gel process requires handling a two-phase slurry. Preventing segregation of the solid phase is a perpetual problem because the solid is very fine carbon powder that readily clumps together. It needs to be a fine powder with a large surface area to allow intimate contact between the metal ions in the liquid phase and the carbon in the solid phase. Subsequent reactions must happen through diffusion across the phase boundary.

To fabricate gel microspheres, a conventional ‘internal gelation’ process requires handling the sol-gel at low temperatures to prevent premature solidification. The gelation process is initiated by the decomposition of an additive that generates ammonia, which increases the pH and causes an abrupt solidification due to precipitation of metal hydroxides.

As solvent is removed, there is typically a precipitation process that causes an abrupt change in the sol-gel viscosity which makes it difficult to process the material. The internal phase boundaries of the sol-gel can also inhibit the chemical reactions that are required to process the sol-gel into a ceramic.

Thus, there are numerous problems with the conventional method of making a sol-gel such as unstable precursors, the requirements for the sol-gel to be stored at a very low temperature, and cracking of resulting gel microspheres during washing and heat treatment. Homogeneous dispersion of nanocarbon in the gel microsphere is challenging. It is not possible to precisely control the carbon content in the gel microsphere. Often times, large excessive amounts of carbon are required. Large grains and pores may be present in the gel microspheres.

Therefore, there is a need for a process that overcomes the disadvantages associated with existing processes. The present invention addresses this need.

### SUMMARY OF THE INVENTION

The present invention relates to a single phase, organic-inorganic sol-gel having a controlled rheology that can be solidified readily and converted into a ceramic material.

In an embodiment of the invention, a method of making a sol-gel is provided. The method comprises combining a metal ion with a chelating agent and a solvent to form a sol mixture, wherein the metal ion is of a metal selected from the group consisting of cerium, uranium, plutonium, zirconium, yttrium, gadolinium, niobium, and a combination thereof, and further processing the sol mixture to form a single phase, organic-inorganic sol-gel. The solvent could be, for example, an acid such as acetic acid, water, or an organic solvent.

In an embodiment of the invention, a pre-polymer material is provided. The pre-polymer material comprises a metal ion selected from the group consisting of cerium, uranium, plutonium, zirconium, yttrium, gadolinium, niobium, and a combination thereof. The pre-polymer material is homogeneous and formable into a solidified form.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a is a flowchart illustrating an embodiment of the method of the present invention for organic-inorganic precursor material synthesis.

FIG. 2 is a graph of XPS results.

FIG. 3 is a graph of XPS results.

FIGS. 4A and 4B are graphs illustrating surface tension and viscosity.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

The present invention provides a method of producing a single phase sol-gel that prevents phase separation and allows for the inclusion of carbon in the same phase as the metal ions. The sol-gel of the present invention, also referred to herein as a pre-ceramic polymer or a pre-polymer, is an organic-inorganic hybrid material meaning it is made of organic and inorganic components. In the method of the present invention, the metal ions form an oxide or hydroxide as the sol-gel solidifies, but react with carbon to form a carbide at high temperature.

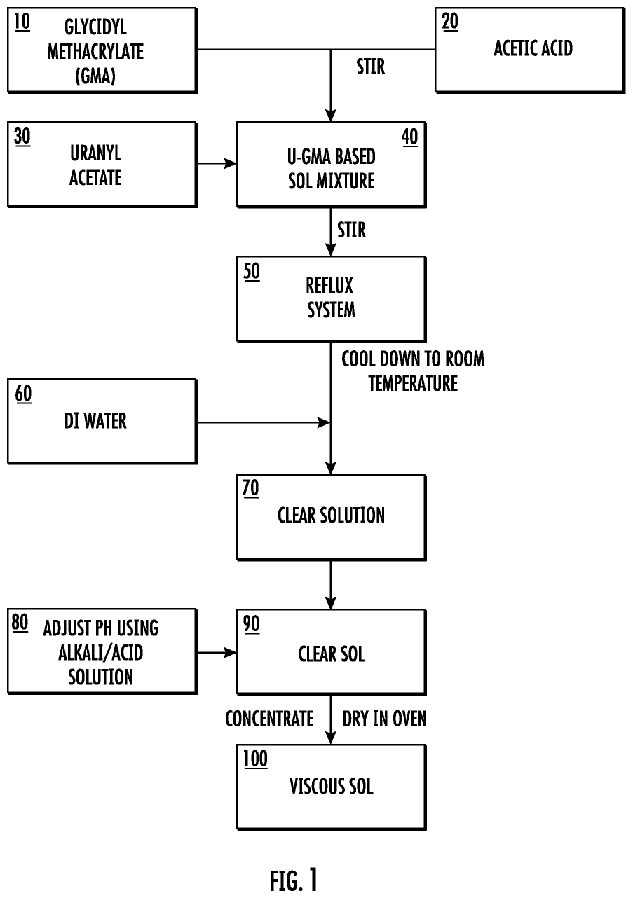

Referring to the figures, FIG. 1 is a flowchart illustrating an embodiment of the method of the present invention for uranium organic-inorganic precursor synthesis. As shown in FIG. 1, glycidyl methacrylate (GMA) 10 is combined with acetic acid 20. GMA may be used as a chelating agent, crosslinker, monomer, or a combination thereof in the present invention. Although GMA is preferably used to serve all three functions it is also possible to use, for example, one compound to serve as chelating agent and monomer then use another compound as the crosslinker.

One of the benefits of using glycidyl methacrylate (GMA) as a chelating agent is GMA can keep the metal ions in solution even if all of the solvent is removed. The solvent free sol-gel can solidify in an oil bath or other convenient environment without having to provide careful control of the solvent evaporation rate, which greatly simplifies the process. The solidification process is driven by two separate chemical reactions, one is the hydrolysis of the metal ions and the other is the polymerization reactions between the GMA molecules. It is the dual functionality of the GMA molecule that makes this process unusual as GMA can serve as both a polymerization monomer and a chelating agent. Sol-gels that are made by the method of the present invention are suitable for processing into oxide ceramics by driving of the organic component and completely oxidizing the metal ions by heating in an oxidizing environment.

The sol-gel can alternatively be processed by adding another polymer as a source of additional carbon. For example, a phenolic resin can be dissolved into the GMA and acetic acid solution. When GMA is in the presence of the phenolic resin, GMA acts as a crosslinker, which also helps to solidify the sol-gel. Although phenolic resin may be used, it is possible to use polyester resin or no resin at all.

Some metals can be converted from oxide to carbide by heat treating in the presence of sufficient carbon. Some metals can also be converted from carbide to nitride in the presence of nitrogen or ammonia gas. For example, cerium can be processed from a homogeneous liquid solution to a sol-gel, then further processed into oxide, carbide, and nitride. Although the sol-gel may be converted into oxide, carbide, and nitride forms, it is also possible to make borides, phosphides, silicides, or intermediate forms like oxynitride, among others.

The preferred metal ions for use in the method of the present invention are cerium and uranium, but other possible metals that could be used include, but are not limited to, plutonium, zirconium, yttrium, gadolinium, niobium, and a combination thereof.

The preferred anion for use in the method of the present invention is acetate, other possible anions that could be used include, but are not limited to, nitrate.

The process could be controlled with the addition of polymerization initiators, crosslinkers, and catalysts.

Referring to FIG. 1, uranyl acetate (UO₂(AC)₂) powder 30 and acetic acid 20 with glycidyl methacrylate (GMA) 10 and deionized (DI) water are weighted and charged in a flask. The contents of the flask are stirred at room temperature. The molar ratio between GMA and UO₂²⁺ is in a range of from 0.8:1 to 6:1, preferably 1:1. After stirring, a uranyl acetate suspension 40 is obtained because uranyl acetate is not completely dissolved in the solution. The flask with uranyl acetate suspension is fixed on a reflux system 50 having an oil bath at a temperature in a range of from 50° C. to 100° C., preferably 70° C. to 90° C. The condenser needs to operate efficiently so as to prevent solvent loss, and cooling water is typically at a temperature in a range of from 0° C. to 50° C. An objective at this stage is complete dissolution of the solids and hydrolysis of the GMA. The reflux typically lasts for a time period such as 1 hour to 72 hours, and the suspension becomes a clear and homogenous yellow solution 70. The solution is homogeneous (no phase separation) and stable from room temperature to 100° C.

The method further comprises adjusting the pH value of the solution. After reflux, the solution cools down to room temperature and additional deionized (DI) water 60 is added to the solution. After the DI water is added, the pH value of the sol is adjusted 4.5 to 5.5 using an alkali/acid solution 80 such as NH₃ water solution. The solution is preferably under constant shaking while the ammonia solution is added to make sure the homogeneity and avoid precipitation.

The sol 90 is distributed, for example, into glass vials and the vials are placed in a secondary glass container to contain any spills. The method further comprises drying. The vials and secondary container are placed in an oven at a temperature in a range of from 50° C. to 150° C., preferably 80° C., and the drying process usually takes 10 hours to 20 days. Various drying methods may be employed. The dilute sol becomes dark red and high viscous sol 100. Eventually, the sol will become homogenous highly viscous sol without any precipitation.

In an embodiment of the present invention, a variety of materials can be made using the sol-gel method of the present invention. Highly spherical ceramic microspheres such as uranium gel microspheres are fabricated. For example, pure phase UC₂ can be obtained upon carbothermal reaction at 1500° C. for approximately 4 hours in vacuum. Pure phase U₂N₃ can be obtained after converting UC₂ to U₂N₃ at 1200° C. for approximately 48 hours in nitrogen gas.

In an embodiment of the present invention, uranium nitride (U₂N₃) microspheres are fabricated before sintering. The uranium nitride microspheres are typically fabricated in three stages. In the first stage, uranium-based organic-inorganic precursor is synthesized. The precursor needs to be homogeneous without precipitation to avoid compositional segregation and non-uniform microstructure in the later stages. In the second stage, precursor droplets are generated using a syringe with a needle. The droplets slowly sediment within a highly viscous polybutadiene solution. Usually the sedimentation takes more than 10 hours. During this sedimentation process, the precursor droplets undergo crosslinking and solidification. In the third stage, the solidified droplets are subjected to heat-treatment first to be converted to uranium carbide microspheres and then to uranium nitride microspheres. Further sintering may be needed if fully dense microspheres are desired.

For example, after having obtained the highly viscous sol-gel, liquid phenolic resin is added into the highly viscous sol and the vial kept in an oven at a temperature in a range of from 50° C. to 175° C. for a curing period of up to 20 days. The dark red and homogenous organic-inorganic precursor is ready for carbide and nitride fabrication.

The liquid medium for droplet sedimentation is made of 30 wt % to 35 wt % polybutadiene (PBD) in hexadecane solution. To complete dissolve PBD in hexadecane, the PBD-hexadecane mixture is placed in an oven at a temperature in a range of from 50° C. to 100° C., preferably 60° C. to 80° C., for 10 hours to 20 days, preferably 5 days to 15 days and stirred occasionally. After several days, a homogenous polymer solution is obtained with the viscosity in a range of from 1500 Poise to 3000 Poise.

Benzoyl peroxide (BPO) is a non-limiting example of a suitable free radical initiator. Other initiators include, but are not limited to, azobisisobutylnitrile (AIBN) and many others that are familiar to polymer chemists, for example. Non-limiting examples of suitable solvents include but are not limited to, toluene, acetone, and tetrahydrofuran (THF), among others.

In the case of BPO, BPO as initiator is dissolved in a solvent such as toluene to form an initiator solution. The initiator solution has a concentration in a range of from 15 wt % to 20 wt %. The solution is typically colorless and clear.

Another non-limiting example is 1 mole of AIBN per 100 moles GMA dissolved in THF.

Droplet generation may occur by syringe injection. The organic-inorganic precursor obtained as above discussed is diluted using acetic acid into 2M sol. The weight ratio of BPO/sol is in a range of from 0.5 wt % to 20 wt %, preferably 2 wt % to 10 wt %. The solution is shaken well by hand to ensure homogeneity.

Dimethylformamide (DMF) is also a suitable solvent. A 2M concentration is suitable for making droplets by hand, but the resin could be diluted to achieve the appropriate viscosity for any potential application. For example, a casting resin may be diluted with less solvent to make a higher viscosity.

The droplet generation may be carried out using a syringe with a needle. The droplets form spherical shape due to the surface tension and sink into the polymer solution with extremely slow velocities. Usually it takes a time period in a range of 10 hours to 10 days for the droplets to sediment from the surface of polybutadiene solution to the bottom of the beaker.

For example, it may take a time period of from 2 minutes to 2 days for the gelation at a temperature in a range of from 50° C. to 200° C. However, time and temperature may vary depending upon the initiator, solvent, and the application as these conditions are also dependent upon the depth of the beaker and the viscosity of the polybutadiene solution and may be adjusted to suit the application.

However, droplets may remain in PBD solution for a longer period of time such as from 2 minutes to 2 days at a temperature in a range of from 50° C. to 200° C. to ensure satisfactory mechanical strength of gel microspheres for handling. The solid organic-inorganic precursor microspheres are scooped out of the polymer solution and gently wiped clean before heat treatment.

Carbothermal reduction is used to form uranium carbide microspheres. The solid gel microspheres are placed in a molybdenum (Mo) foil crucible and the Mo crucible is placed in an alumina (Al₂O₃) crucible. A tube furnace is used to carry out carbothermal reduction to form carbide microsphere. Usually the furnace tube is evacuated to less than 300 mTorr before backfilling with flowing Ar. The microspheres are heated to a temperature in a range of 1100° C. to 1900° C., preferably 1700° C., at 0.2° C./min and kept for a time period in a range of from 30 minutes to 2 days, preferably 5 h, under flowing Ar, and then cooled down in the furnace to room temperature. Alternatively, the microspheres may be heated in flowing argon to a temperature in the range of 400° C. to 900° C., preferably 600° C., at 0.2° C./min to pyrolyze the polymer and produce an amorphous inorganic intermediate precursor. The intermediate precursor may be heated in vacuum to a temperature in a range from 1100° C. to 1900° C., preferably 1500° C., at 0.2° C./min to produce uranium carbide by carbothermal reduction.

After the carbothermal reduction to form uranium carbide, the microspheres are heated to a temperature in a range of 500° C. to 1400° C., preferably 1200° C. at 1° C./min for a time period in a range of from 30 minutes to 10 days, preferably 48 hours. The flowing gas is forming a H₂ to N₂ gas mixture. The H₂ to N₂ ratio is in a range of from 0 to 1.

Although a sol-gel of the present invention may be used to produce a polymeric microsphere and converted into a ceramic microsphere. The same material could be used to create ceramic fibers, films, or coatings. It is also possible that a polymer with a high metal loading might be used, for example, as an ion exchange resin, electrolytic membrane, biocompatable polymer, antibacterial coating, electrically conductive polymer, high optical density plastic, or customizable optical coating.

There are numerous advantages associated with the method of the present invention. Since the method of the present invention forms a homogeneous single-phase sol-gel, there is no potential segregation. The method of the present invention uses a thermally stable sol-gel that solidifies through a polymerization reaction without any precipitation.

Another advantage of the present invention is the fact that the combination of acetic acid and GMA allows the metal ions to remain in solution even when nearly all the water is removed. The controlled shift from aqueous solution to organic solution without precipitation greatly increases the number of use cases for the sol-gel.

Still yet another advantage is the method of the present invention provides a homogeneous (no phase separation) liquid precursor that can be cross-linked with organic initiator, without the need of solvent evaporation.

In another embodiment of the present invention, a pre-ceramic polymer or pre-polymer is provided that is suitable for producing non-silicon ceramics using a wide variety of metal ions because the polymerization reaction is not affected by the chemistry of the metal ion.

The pre-polymer material comprises a metal ion selected from the group consisting of cerium, uranium, plutonium, zirconium, yttrium, gadolinium, niobium, and a combination thereof. The pre-polymer material is homogeneous and formable into a solidified form.

Thermoset resins can be produced that contain high concentrations of metal ions and variable carbon content to make ceramics in the form of oxides, carbides, or nitrides. The pre-ceramic polymers of the present invention are amenable to other net-shape manufacturing processes such as injection molding, extrusion, and casting. The liquid resin is compatible with several solvents, and the viscosity can be adjusted to make thin films or coatings. A variety of different free-radical initiators can be used to make resins that cure at different temperatures or start curing with exposure to UV light.

Examples of pre-ceramic polymer or pre-polymer applications include, but are not limited to, catalysts, piezoelectric films or fibers, ultrahigh temperature ceramics, optical coatings and lenses, metal matrix composite additives, superparamagnetic materials, among others.

In regard to use as a catalyst, the pyrolysis product of the pre-ceramic polymer of the present invention is a porous, amorphous carbon with a high metal-ion loading. The metal-ions could be reduced to elemental metal or converted into carbide to produce a variety of different non-platinum catalysts.

In regard to use as a piezoelectric film or fiber, the preceramic polymer of the present invention could be processed into piezoelectric transducers using a variety of alternative manufacturing techniques to make smaller, higher frequency devices. Lead lanthanate zirconate titanate (PLZT) or lead zirconate titanate (PZT) are non-limiting examples of very high piezoelectric-constant materials. The piezoelectric film or fiber could be used, for example, to build custom composite ultrasound transducers for high-frequency applications.

In regard to use as an optical coating and lens, the pre-ceramic polymer of the present invention is homogeneous and has a high metal ion concentration with makes it suitable for potential optical applications such as high performance plastic lenses. A polymer with an index of refraction near n=2.0 would allow for the production of custom optical coatings on temperature sensitive substrates. A wide variety of different metal additives could be used to make custom optical filters. The liquid resin precursor can be cast into shape or applied as a coating.

In regard to use as metal matrix composite additives, the carbide or nitride fibers could be used in metal matrix composites (MMC). The resulting MMC materials could be used for high temperature applications.

### EXAMPLE

Molecule structure studies were conducted.

X-ray photoelectron spectroscopy (XPS) and Ultraviolet-visible spectroscopy (UV-vis) were used to study the mixture of Ce³⁺ and UO²⁺ with GMA with different mole ratios (e.g. ranging from 1:0.5 to 1:2) of GMA: metal ions in the precursor.

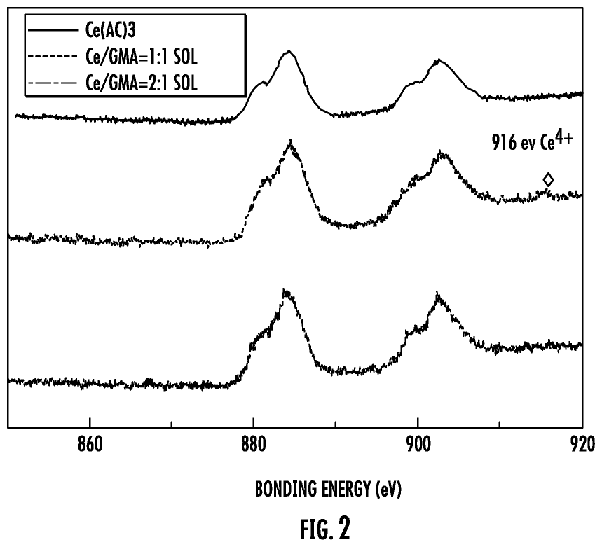

Preliminary XPS results showed that there were no valency changes during the reaction, since there was an absence of 916 eV peak for Ce⁴⁺. Results are shown in the graph of FIG. 2.

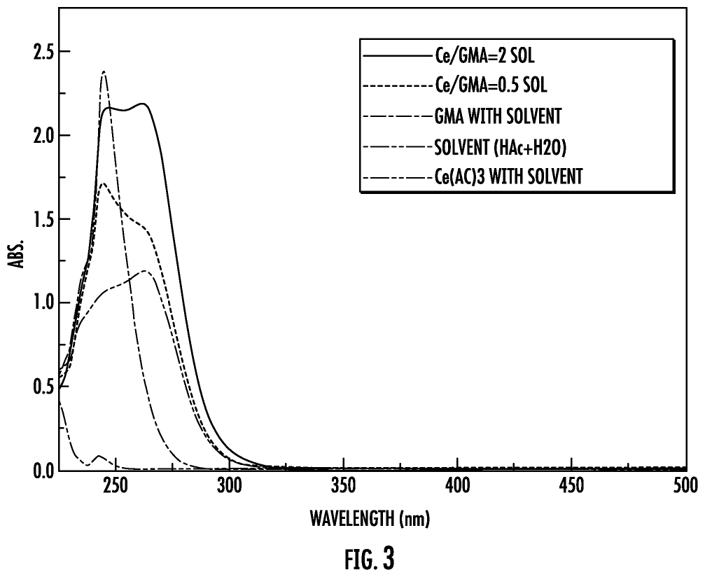

Preliminary results showed no spectroscopic evidence of chelation reaction between Ce³⁺ and GMA. There was no new peak for the metal ion complex. Results are shown in the graph of FIG. 3.

XPS and UV-vis results showed no spectroscopic evidence of a chelation reaction but the organic-inorganic hybrid material was a stable and homogenous inter-molecular mixture. This indicates that it was a Class 1 hybrid material in which organic and inorganic compounds are embedded and only weak bonds (hydrogen, van der Waals or ionic bonds) giving the cohesion to the whole structure.

The hydrolyzed GMA stabilized the metal ions by the interaction between hydroxyl groups on the GMA and the metal ions.

Raman mapping image of Ce-GMA based sol (Ce3+/GMA=1:2 molar ratio) at room temperature (Scale bar=3 μm) was conducted. The sol and the resulting pre-ceramic polymer are homogeneous and no phase segregation was observed.

### EXAMPLE

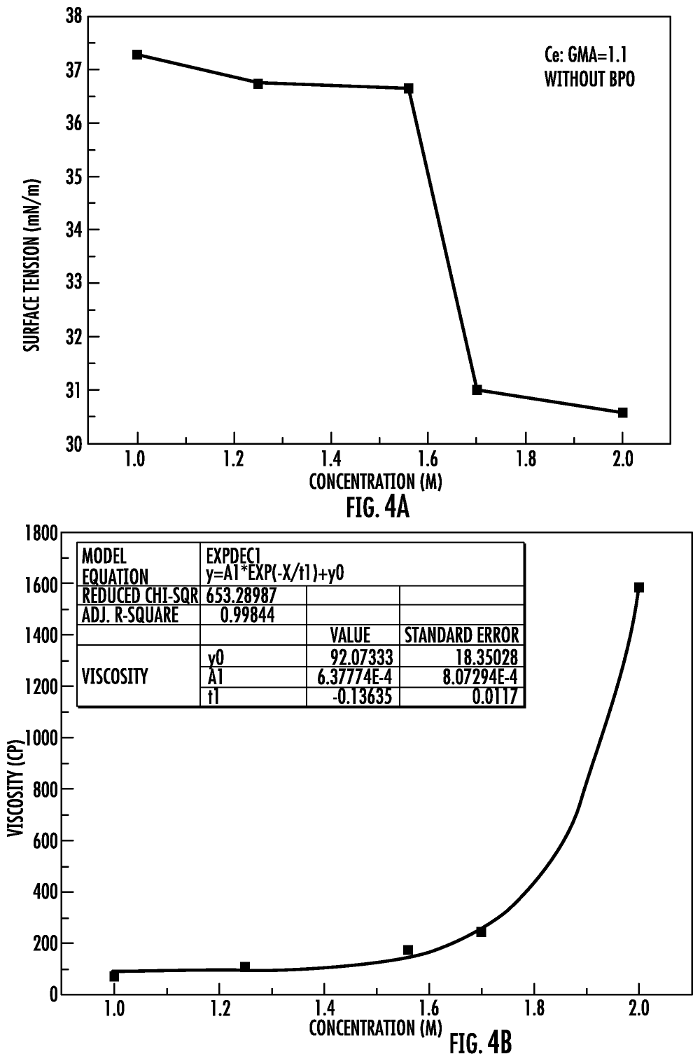

Experiments were conducted for viscosity and surface tension. The viscosity and surface tension which are important factors for the microsphere fabrication, were well controlled. Viscosity increased as the concentration increased (without initiator and phenolic resin at room temperature). The viscosity of the Ce-GMA sol showed shear thinning behavior. Results are shown in the graphs of FIGS. 4A and 4B.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of making a sol-gel, the method comprising:
combining a metal ion with a chelating agent and a solvent to form a sol mixture, wherein the metal ion is of a metal selected from the group consisting of cerium, uranium, plutonium, zirconium, yttrium, gadolinium, niobium, and a combination thereof.
and
processing the sol mixture to form a single phase, organic-inorganic sol-gel.

2. The method according to claim 1, wherein the chelating agent is glycidyl methacrylate or the hydrolyzed form of glycidyl methacrylate (glycerol methacrylate).

3. The method according to claim 1, wherein the metal is uranium.

4. The method according to claim 1, wherein the metal is cerium.

5. The method according to claim 1, further comprising fabricating a ceramic microsphere from the organic-inorganic sol-gel.

6. The method according to claim 5, further comprising converting the ceramic microsphere to a homogeneous ceramic after thermal decomposition at a high temperature.

7. The method according to claim 6, wherein pure phase UC₂ is obtained upon carbothermal reaction.

8. The method according to claim 7, wherein pure phase U₂N₃ is obtained after converting UC₂ to U₂N₃.

9. The method according to claim 1, further comprising adding a phenolic resin as a carbon source.

10. A pre-polymer material comprising:
a metal ion selected from the group consisting of cerium, uranium, plutonium, zirconium, yttrium, gadolinium, niobium, and a combination thereof,
wherein the pre-polymer material is homogeneous and formable into a solidified form.

11. The pre-polymer material according to claim 10, wherein the solidified form is selected from the group consisting of a film, a fiber, a coating, a 3D printed object, and a combination thereof.

12. The pre-polymer material according to claim 10, wherein the solidified form is present in a catalyst, a piezoelectric film or fiber, an ultrahigh temperature ceramic, an optical coating, an optical lens, a metal matrix composite additive, or a superparamagnetic material.
